(19) United States
(12) Patent Application Publication
(10) Pub. No.: US 2026/0234076 A1
(43) Pub. Date: Aug. 13, 2026

(54) USE OF A COMPOSITION OF TRICHODERMA AND LIGNIN FRACTION AS A BOOSTER OF NITROGEN FERTILIZERS

(71) Applicants: UPM-KYMMENE CORPORATION, Helsinki (FI); GREEN INNOVATION GMBH, Innsbruck (AT)

(72) Inventors: Suvi Pietarinen, Helsinki (FI); Christian Hubsch, Helsinki (FI); Giuliano Leonardi, Innsbruck (AT); Vito Macchia, Innsbruck (AT)

(21) Appl. No.: 19/155,363

(22) PCT Filed: Feb. 8, 2024
(86) PCT No.: PCT/EP2024/053223

§ 371 Date: Aug. 11, 2025

(30) Foreign Application Priority Data
Feb. 15, 2023 (IT) 102023000002589

(51) Int. Cl. C05F 11/08; C05C 1/00; C05F 5/00; C05G 5/00; C05G 5/12

(52) U.S. Cl. CPC C05F 11/08; C05C 1/00; C05F 5/002; C05G 5/12; C05G 5/45

(57) ABSTRACT

A method is shown for making, using, and applying a composition including a fungus of Trichoderma genus and a lignin fraction as a booster of nitrogen fertilizers. In particular, it was observed that methods of applying nitrogen fertilizers that include such a composition surprisingly enhances the uptake of nitrogen by plant seeds so that the overall amount of the fertilizer to be applied can be advantageously reduced down to at least 50% of the recommended amount. An agro-chemical kit is shown that includes a fungus of Trichoderma genus in a first container, and a lignan fraction and a nitrogen-containing fertilizer in either separate second and third containers or in a single second container.

### FIELD OF THE INVENTION

The present invention concerns the use of a composition comprising a fungus of Trichoderma genus and a lignin fraction, as a booster of nitrogen fertilizers. In particular, it was observed that said composition surprisingly enhances the seed uptake of nitrogen from nitrogen fertilizers, so that the overall amount of the latter to be applied can be advantageously reduced down to at least 50%.

### STATE OF THE ART

Fertilizer, which essentially consisting of various types of nutritive components for plant growth, has been widely employed throughout the world to improve the yields of agriculture products. Generally, fertilizers may be in the forms of liquid, suspensions or solid.

It is well known that NPK fertilizers represent the primary products used for supplementing the nutritional requirements of flowers, trees, grasses, and agricultural crops. The “NPK” meaning reflects the three nutrient elements found in these fertilizers, i.e. nitrogen, phosphorus, and potassium.

Nitrogen takes on an array of different functions in the plant and is therefore particularly important. Mainly, it is responsible for plant growth and regeneration. If there is too little nitrogen present, the plants do not grow sufficiently and any yield decreases. An excess, however, has several disadvantages: it leads to delayed flowering and fruit ripening; plant tissue becomes very soft and therefore less stable; and eventually, diseases and pests are more likely, which is what leads to a reduction in yield.

Phosphorus, which is also a main nutritional element in plants, cares for the transmission and storage of chemical energy, as well as root formation. In addition, it is essential for photosynthesis. Thus, phosphorus is helpful from the beginning, meaning that it supports the seed, for example, during fertilization. But also later during the blooming period. A lack of phosphorus causes plants to remain small and stunted and stalks to remain thin.

What's more, the leaves turn colour, the roots hardly grow and flowering is delayed. In contrast, a (rarely occurring) excess of phosphorus damages the plants indirectly, by reducing the amount of trace elements available.

Potassium, the third essential nutrient, provides for water absorption and thus for an appropriate balance of water in the plant. That also leads to strong plant tissue and a high resilience and resistance. At the same time, it promotes resistance to diseases, extreme weather conditions, such as the cold, etc. A lack of potassium makes the plant become limp and impairs formation of the root. In addition, the plant transpires more during dry periods and takes less water. Too much potassium causes a disadvantageous concentration of salt and thus a reduced intake of positive nutrients, such as magnesium, etc.

Therefore, it is advisable to find a good balance of concentration of nutrients in the fertilizers, so as to exploit their efficacy and reducing drawbacks.

It should be also noted that the use of nitrogen fertilizers is going through a period of crisis due to high production costs, while similarly, overuse of phosphorus has been criticized due to its environmental impact.

It is therefore felt the need to reduce the overall use of fertilizers, by effectively and properly exploit the same, at the same time providing a sufficient quantity of nutrients to a plant, while preserving the human and animal health, the crop and environment.

### SUMMARY OF THE INVENTION

The above object has been achieved by using a composition comprising a fungus of Trichoderma genus and a lignin fraction, as a booster of nitrogen uptake by plant seeds from a nitrogen-containing fertilizer, as claimed in claim 1.

In another aspect, the present invention concerns an agro-chemical kit comprising—a first container containing a fungus of Trichoderma genus,—a second container comprising a lignin fraction, and—a third container comprising a nitrogen-containing fertilizer, or—a second container comprising a lignin fraction and a nitrogen-containing fertilizer.

In a further aspect, the present invention concerns a method for increasing the nitrogen uptake by plant seeds, said method comprising the step of applying the composition to seed soil, and thereafter applying a nitrogen-containing fertilizer.

The term “seed” or “seeds” is meant to include not only plant seeds, but also tubers and bulbs.

The term “plant” denotes a plant or plants that can be grown and harvested for profit or subsistence, thus including crops, cereals, vegetables, fruits, and flowers, as well as grown and harvested for gardening or personal use.

The term “soil” denotes the soil where the seeds are sowed, thus including grounds, lands, and soilless media, such as in hydroculture and hydroponics.

### BRIEF DESCRIPTION OF THE FIGURES

The characteristics and the advantages of the present invention will become clear from the following detailed description, the working examples provided for illustrative purposes, and the accompanying figures, wherein:

FIGS. 1-5 relate to the study on corn seedlings as per Example 6, performed from Dec. 15, 2021 to Jan. 14, 2022, while comparing the following differently treated samples:
“untreated check”, i.e. corn seedlings receiving no treatment,
“normal fertilizer”, i.e. corn seedlings receiving 150 kg/ha of ammonium nitrate, as fertilizer, at the time of sowing,
“Comp. Inv. 100 g/m³”, i.e. corn seedlings receiving 100 g/m³ of a mixture of Trichoderma GV41 and lignin fraction, at the time of sowing,
“Comp. Inv. 100 g/m³, Norm. Fert.”, i.e. corn seedlings receiving 100 g/m³ of a mixture of Trichoderma GV41 and lignin fraction, and 150 kg/ha of ammonium nitrate, at the time of sowing,
“Comp. Inv. 100 g/m³, ½ Fert.”, i.e. corn seedlings receiving 100 g/m³ of a mixture of Trichoderma GV41 and lignin fraction, and 75 kg/ha of ammonium nitrate, at the time of sowing,
“Comp. Inv. 500 g/m³”, i.e. corn seedlings receiving 500 g/m³ of a mixture of Trichoderma GV41 and lignin fraction (Composition of the Invention), at the time of sowing,
“Comp. Inv. 500 g/m³, Normal Fertilizer”, i.e. corn seedlings receiving 500 g/m³ of a mixture of Trichoderma GV41 and lignin fraction, and 150 kg/ha of ammonium nitrate, at the time of sowing,
“Comp. Inv. 500 g/m³, ½ Fertilizer”, i.e. corn seedlings receiving 500 g/m³ of a mixture of Trichoderma GV41 and lignin fraction, and 75 kg/ha of ammonium nitrate, at the time of sowing;
   and specifically
FIG. 1 shows the trend of SPAD [i.e. Soil Plant Analysis Development chlorophyll meter is a rapid and non-destructive approach for measuring the chlorophyll content, thus determining in situ nitrogen (N) status] of corn seedlings of Example 6,
FIG. 2 shows the uptake of nitrogen of the corn seedlings of Example 6;
FIG. 3 shows the “PE Nitrogen” [i.e. the physiological efficiency (PE) denoting the ability of the plant to transform Nitrogen acquired from the source applied into economic yield] of the corn seedlings of Example 6;
FIG. 4 shows the “AE Nitrogen” [i.e. the agronomic efficiency (AE) denoting the productivity improvement gained by use of Nitrogen input] of the corn seedlings of Example 6;
FIG. 5 shows the “IE Nitrogen” [i.e. the Internal utilization efficiency (IE) denoting the ability of the plant to transform Nitrogen acquired from all sources into economic yield] of the corn seedlings of Example 6.

FIGS. 6-10 relate to the study on wheat seedlings as per Example 7, performed from Dec. 15, 2021 to Jan. 14, 2022, while comparing the following differently treated samples:
“untreated check”, i.e. wheat seedlings receiving no treatment,
“normal fertilizer”, i.e. wheat seedlings receiving 150 kg/ha of ammonium nitrate, as fertilizer, at the time of sowing,
“Comp. Inv. 100 g/m³”, i.e. wheat seedlings receiving 100 g/m³ of a mixture of Trichoderma GV41 and lignin fraction, at the time of sowing,
“Comp. Inv. 100 g/m³, Norm. Fert.”, i.e. wheat seedlings receiving 100 g/m³ of a mixture of Trichoderma GV41 and lignin fraction, and 150 kg/ha of ammonium nitrate, at the time of sowing,
“Comp. Inv. 100 g/m³, ½ Fert.”, i.e. wheat seedlings receiving 100 g/m³ of a mixture of Trichoderma GV41 and lignin fraction, and 75 kg/ha of ammonium nitrate, at the time of sowing,
“Comp. Inv. 500 g/m³”, i.e. wheat seedlings receiving 500 g/m³ of a mixture of Trichoderma GV41 and lignin fraction, at the time of sowing,
“Comp. Inv. 500 g/m³, norm fert”, i.e. wheat seedlings receiving 500 g/m³ of a mixture of Trichoderma GV41 and lignin fraction, and 150 kg/ha of ammonium nitrate, at the time of sowing,
“Comp. Inv. 500 g/m³, ½ fert”, i.e. wheat seedlings receiving 500 g/m³ of a mixture of Trichoderma GV41 and lignin fraction, and 75 kg/ha of ammonium nitrate, at the time of sowing;
   and specifically
FIG. 6 shows the trend of SPAD of wheat seedlings of Example 7,
FIG. 7 shows the uptake of nutrients, i.e. nitrogen, phosphorus and potassium, of the wheat seedlings of Example 7;
FIG. 8 shows the “PE Nitrogen” of the wheat seedlings of Example 7;
FIG. 9 shows the “AE Nitrogen” of the wheat seedlings of Example 7;
FIG. 10 shows the “IE Nitrogen” of the wheat seedlings of Example 7;

FIGS. 11-13 relate to the study on soy seedlings as per Example 8, performed from Dec. 15, 2021 to Jan. 14, 2022, while comparing the following differently treated samples:
“untreated check”, i.e. soy seedlings receiving no treatment,
“normal fertilizer”, i.e. soy seedlings receiving 150 kg/ha of ammonium nitrate, as fertilizer, at the time of sowing,
“Comp. Inv. 100 g/m³”, i.e. soy seedlings receiving 100 g/m³ of a mixture of Trichoderma GV41 and lignin fraction, at the time of sowing,
“Comp. Inv. 100 g/m³, Norm. Fert.”, i.e. soy seedlings receiving 100 g/m³ of a mixture of Trichoderma GV41 and lignin fraction, and 150 kg/ha of ammonium nitrate, at the time of sowing,
“Comp. Inv. 100 g/m³, ½ Fert.”, i.e. soy seedlings receiving 100 g/m³ of a mixture of Trichoderma GV41 and lignin fraction, and 75 kg/ha of ammonium nitrate, at the time of sowing,
“Comp. Inv. 500 g/m³”, i.e. soy seedlings receiving 500 g/m³ of a mixture of Trichoderma GV41 and lignin fraction, at the time of sowing,
“Comp. Inv. 500 g/m³, norm fert”, i.e. soy seedlings receiving 500 g/m³ of a mixture of Trichoderma GV41 and lignin fraction, and 150 kg/ha of ammonium nitrate, at the time of sowing,
“Comp. Inv. 500 g/m³, ½ fert”, i.e. soy seedlings receiving 500 g/m³ of a mixture in of Trichoderma GV41 and lignin fraction, and 75 kg/ha of ammonium nitrate, at the time of sowing;
   and specifically
FIG. 11 shows the trend of SPAD of soy seedlings of Example 8,
FIG. 12 shows the uptake of nitrogen of the soy seedlings of Example 8; and
FIG. 13 shows the “PE Nitrogen” of the soy seedlings of Example 8.

### DETAILED DESCRIPTION OF THE INVENTION

The subject of the invention therefore is the use of a composition comprising a fungus of Trichoderma genus and a lignin fraction, as a booster of nitrogen uptake by plant seeds receiving nitrogen-containing fertilizer, wherein:
said fungus is selected from Trichoderma species, their protoplast fusants, and mixtures thereof,
said lignin fraction comprises fragments having a weight average molecular weight up to 20,000 Daltons, as measured by Size-Exclusion Chromatography, said
fragments comprising up to 111 phenylpropane units on weight average, and wherein the fungus is in a concentration of 1×10⁵ to 5×10¹⁰ spores/g of composition, and the lignin fraction in a concentration of at least 40 wt %, based on the weight of the composition.

Preferably, the composition is in the form of an aqueous solution, dispersion, or suspension, or alternatively in the form of a solid admixture.

Preferably, said Trichoderma species is selected from Trichoderma aggressivum, Trichoderma asperellum, Trichoderma atroviride, Trichoderma citrinoviride, Trichoderma cremeum, Trichoderma harzianum, Trichoderma koningii, Trichoderma longibrachiatum, Trichoderma reesei, Trichoderma virens, Trichoderma viride, and Trichoderma viridescens.

A fungus belonging to Trichoderma genus as defined above are able to colonize a variety of niches, antagonize and control plant pathogenic microorganisms and establish a direct beneficial interaction with plants resulting in the enhancement of growth, nutrient uptake and systemic resistance to diseases. In particular, improvement in plant development is generally associated with increased seed germination, root system, plant weight and leaf area, size and/or number of seeds flowers and/or fruits with a consequent increase in yields and often in the content of important nutritional factors.

Lignin is known to have an antimicrobial activity against both fungi and bacteria. Therefore, it was expected that treatment of Trichoderma, a well know soil-borne fungus, would result in a direct inhibition at concentrations of lignin found toxic for most of the other fungi already tested. Accordingly, the rational expectation was that Trichoderma would have been affected at lignin concentrations typically considered for use in agriculture application. Surprisingly and unexpectedly, Trichoderma species listed above were not only unaffected by the lignin fraction at the given concentrations, but even increased their activity in terms of nitrogen uptake, either naturally present in the soil or supplemented as nitrogen-containing fertilizer.

Particularly, it was observed that the effect on nitrogen uptake is so increased, that it is possible to reduce down to 50% the supplementation of nitrogen-containing fertilizer, while anyway achieving appreciable and comparable results.

In addition to what above, it should be appreciated that Trichoderma species and lignin fraction work in different manners and use different mechanisms: this makes the resulting composition effect to be more robust and suitable in a variety of conditions, while reducing the insurgence of resistance mechanisms (for biocontrol).

Moreover, the production of the composition is simple and cost-effective, since the respective concentrations are advantageously very low. This also means that the composition can be prepared in a concentrated form, that could be easily diluted with water to the concentrations above, before use.

With the term “protoplast fusants” is meant to include hybrid strains of Trichoderma spp. obtained via protoplast fusion.

Protoplasts are the cells of which cell walls are removed and cytoplasmic membrane is the outermost layer in such cells. Protoplast can be obtained by specific lytic enzymes to remove cell wall. Protoplast fusion is a physical phenomenon, during fusion two or more protoplasts come in contact and adhere with one another either spontaneously or in presence of fusion inducing agents. By protoplast fusion, it is possible to transfer some useful genes from one species to another. Protoplast fusion an important tool in strain improvement for bringing genetic recombinations and developing hybrid strains in filamentous fungi. Said improvement can involve for example higher yields in cellulase production.

Protoplast fusants for the purposes of the present invention can be obtained according to techniques known in the art (e.g. Hassan MM (2014) Influence of protoplast fusion between two Trichoderma spp. on extracellular enzymes production and antagonistic activity, Biotechnology & Biotechnological Equipment, 28:6, 1014-1023)

In preferred embodiments of the composition of the invention, the fungus of Trichoderma genus is selected from T. Harzianum, T. Atroviride and T. virens, and mixtures thereof. In some embodiments, the composition comprises a mixture of Trichoderma species. In more preferred embodiments, said fungus is selected from T. Harzianum HK2, T. Atroviride HK4 and T. virens GV41, and mixtures thereof, wherein “HK2”, “HK4” and “GV41” are the respective preferred strains.

HK2 (or simply “K2”) has an ATCC number of PTA-9708 and was disclosed U.S. Pat. No. 8,716,001 (strain RR17Bc).

HK4 (or simply “K4”) has an ATCC number of PTA-9707 and was disclosed in U.S. Pat. No. 8,877,480 (strain WW10TC4).

GV41 (or simply “G41”) is commercially available from BioWorks Inc. NY 14564, USA.

In some embodiments, the composition comprises a mixture of Trichoderma strains. When a mixture is present in the composition, each species or strain is at the same or about the same concentration.

In preferred embodiments, the composition comprises two Trichoderma species or two Trichoderma strains in a concentration ratio of 2:1 to 1:2, preferably 1:1.

Preferably, the fungus is in a concentration of 1×10⁶ to 3×10¹⁰ spores/g of composition. More preferably, the fungus is in a concentration of 1×10⁸ to 2×10¹⁰ spores/g of composition. In preferred embodiments, the fungus is in a concentration of 1×10⁹ to 2×10¹⁰ spores/g of composition.

Lignin is a class of complex organic polymers that form important structural materials in the support tissues of some algae, vascular plants, included their bark, and herbaceous plants, such as wood (i.e. softwood and hardwood), straw of all cereals, cane bagasse, grass, linen, jute, hemp, or cotton. Lignin can also have mineral source, such as peat, leonardite and coal.

Chemically, in its native form, lignin is a very irregular, randomly cross-linked polymer of phenylpropane units joined by many different linkages, with a weight average molecular weight of 20,000 Daltons or higher. A representative and illustrative lignin fragment (I) containing the most important bonding patterns is shown herein below:

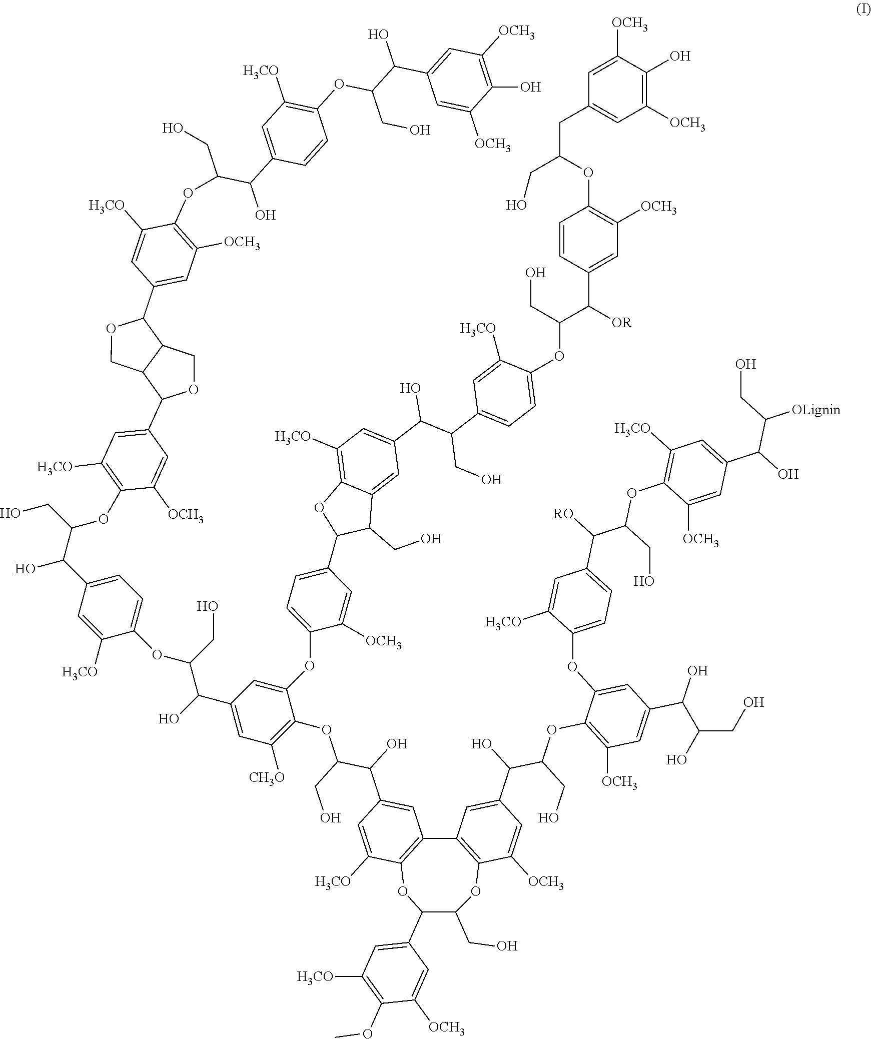

Said polymer is the result of an enzyme-mediated dehydrogenative polymerization of three phenylpropanoid monomer precursors:

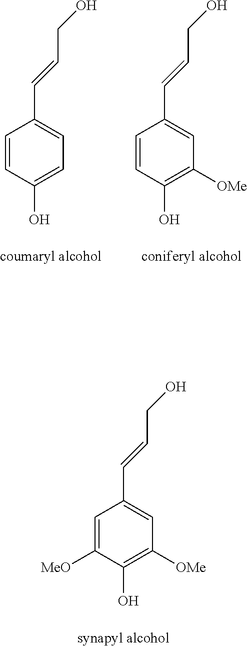 [SMILES: OC/C=C/c1ccc(O)cc1 ; COc1cc(/C=C/CO)ccc1O ; COc1cc(/C=C/CO)cc(OC)c1O]

which result in the following moieties, respectively:

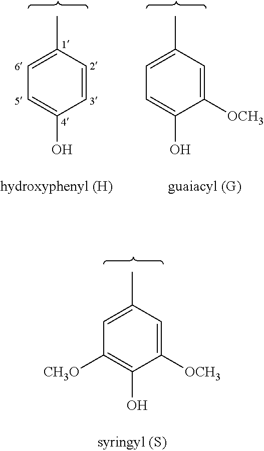

Coniferyl alcohol occurs in all species and is the dominant monomer in conifers (softwoods). Deciduous (hardwood) species contain up to 40% synapyl alcohol units while grasses and agricultural crops may also contain coumaryl alcohol units.

Lignin can be categorized to softwood and hardwood lignins according to their raw biomass sources. For the purposes of the present invention, lignin is softwood lignin, hardwood lignin, or a mixture thereof. Preferably, lignin is hardwood lignin.

Raw biomass sources that can be suitable starting materials for obtaining the relevant lignin fraction are any lignin including essentially pure lignin as well as kraft lignin, biomass originating lignin, lignin from alkaline pulping process, lignin from soda process, lignin from organosolv pulping, lignin from enzymatic processes, lignin from steam explosion processes, and any combination thereof.

By the expression “essentially pure lignin”, it should be understood as at least 80% pure lignin on a dry raw biomass basis, preferably at least 90% pure lignin, more preferably at least 95% pure lignin, the remainder being extractives and carbohydrates such as hemicelluloses as well as inorganic matter.

By the expression “kraft lignin”, it is to be understood lignin that originates from kraft black liquor. Black liquor is an alkaline aqueous solution of lignin residues, hemicellulose, and inorganic chemicals used in a kraft pulping process. The black liquor from the pulping process comprises components originating from different softwood and hardwood species in various proportions. Lignin can be separated from the black liquor by different techniques including e.g. precipitation and filtration. Lignin usually begins precipitating at pH values below 11-12. Different pH values can be used in order to precipitate lignin fractions with different properties. These lignin fractions may differ from each other by molecular weight distribution, e.g. M_{w} and Mₙ, polydispersity, hemicellulose and extractive contents, contents of inorganic material. The precipitated lignin can be purified from inorganic impurities, hemicellulose and wood extractives using acidic washing steps. Further purification can be achieved by filtration.

Alternatively, the lignin is separated from pure biomass. The separation process can begin with liquidizing the biomass with strong alkali followed by a neutralization process. After the alkali treatment, the lignin can be precipitated in a similar manner as presented above. Preferably, the separation of lignin from biomass comprises a step of enzyme treatment. The enzyme treatment modifies the lignin to be extracted from biomass. Lignin separated from pure biomass is essentially sulphur-free (sulphur content less than 3%) and thus valuable in further processing. Preferably, wood material is pre-treated to remove hemicelluloses and thereafter cellulose has been hydrolysed. The resulting insoluble lignin fraction comprises up to 30 wt % of cellulose.

The weight average molecular weight (M_{w}) of fragments in the lignin fraction is measured by Size-Exclusion Chromatography (or ‘SEC’). SEC employs a stagnant liquid present in the pores of beads as the stationary phase, and a flowing liquid as the mobile phase. The mobile phase can therefore flow between the beads and also in and out of the pores in the beads. The separation mechanism is based on the size of the polymer molecules in solution. Bigger molecules will elute first. Small molecules that can enter many pores in the beads take a long time to pass through the column and therefore exit the column slowly. To determine the molecular weights of the components of a polymer sample, a calibration with standard polymers of known weight must be performed. Values from the unknown sample are then compared with the calibration graph. The retention times depend on the used column material, eluent and how similar the used standards are compared to the samples. Preferably, the eluent is preferably 0.1 M NaOH.

Preferably, said lignin fraction comprises fragments having a weight average molecular weight of 2,000-20,000 Da.

More preferably, said lignin fraction comprises fragments having a weight average molecular weight of 3,000-20,000 Da.

Even more preferably, said lignin fraction comprises fragments having a weight average molecular weight of 4,000-15,000 Da.

In some preferred embodiments, said lignin fraction comprises fragments having a weight average molecular weight of 4,000-8,000 Da.

In other preferred embodiments, said lignin fraction comprises fragments having a weight average molecular weight of 9,000-11,000 Da.

Preferably in these embodiments, said fragments comprise 11-111 phenylpropane units on weight average, more preferably, 22-111 phenylpropane units on weight average.

The molecular weight of the three phenylpropanoid monomer precursors varies between 150 Da of coumaryl alcohol, 180 Da of coniferyl alcohol, and 210 Da of synapyl alcohol.

The average weight is therefore 180 Da and this value has been used as “phenylpropane unit”. The M_{w} values have been divided by 180 Da, thus obtaining the phenylpropane unit numbers on weight average.

Preferably, the lignin fraction comprises fragments having a number average molecular weight (Mₙ) up to 2,000 Daltons.

For the purposes of the present invention, the number average molecular weight (Mₙ) of fragments in the lignin fraction is measured by Size-Exclusion Chromatography.

More preferably, the lignin fraction comprises fragments having a number average molecular weight (Mₙ) up to 1,500 Daltons.

In preferred embodiments, said lignin fraction comprises fragments having a number average molecular weight of 150 Daltons to 1,300 Daltons.

In further embodiments, the lignin fraction has a polydispersity index (PDI) of 1.25 to 12. The polydispersity index (PDI) or heterogeneity index, or simply dispersity, is a measure of the distribution of molecular mass in a given polymer sample. PDI is the weight average molecular weight (M_{w}) divided by the number average molecular weight (Mₙ). It indicates the distribution of individual molecular masses in a batch of polymers.

The fungus of Trichoderma genus produces cellulose-degrading enzymes such as exoglucanase (EXG), endoglucanase (EG) and β-glucosidase (BGL). Cellulases are the most efficient enzyme system for the complete hydrolysis of cellulosic substrates into its monomeric glucose, which is a fermentable sugar. As sugar helps plant cellular respiration and cell growth, it follows that the presence of cellulose in the composition of the invention is advantageous for further improving the overall efficiency in promoting the plant growth.

Preferably, the composition of the invention comprises the lignin fraction in a concentration of at least 60 wt %, based on the weight of the composition, more preferably, at least 70 wt %. In preferred embodiments, the composition of the invention comprises the lignin fraction in a concentration of 75-95 wt %, based on the weight of the composition.

In preferred embodiments, the composition of the invention comprises a fungus of Trichoderma genus and a lignin fraction, wherein:
said fungus is selected from Trichoderma harzianum, Trichoderma atroviride Trichoderma virens, and mixtures thereof,
said lignin fraction comprises fragments having a weight average molecular weight of 3,000-20,000 Daltons, as measured by Size-Exclusion Chromatography,
said fragments comprising 16-111 phenylpropane units on weight average,
   and wherein the fungus is in a concentration of 1×10⁵ to 5×10¹⁰ spores/g of composition,
   and the lignin fraction in a concentration of at least 40 wt %, based on the weight of the composition.

More preferably, the composition of the invention comprises a fungus of Trichoderma genus and a lignin fraction, wherein:
said fungus is selected from Trichoderma harzianum, Trichoderma atroviride Trichoderma virens, and mixtures thereof,
said lignin fraction comprises fragments having a weight average molecular weight of 3,000-20,000 Daltons, as measured by Size-Exclusion Chromatography, said fragments comprising 16-111 phenylpropane units on weight average,
   and wherein the fungus is in a concentration of 1×10⁶ to 3×10¹⁰ spores/g of composition, and the lignin fraction in a concentration of at least 60 wt %, based on the weight of the composition.

In some preferred embodiments, the composition of the invention comprises a fungus of Trichoderma genus and a lignin fraction, wherein:
said fungus is selected from Trichoderma harzianum HK2, Trichoderma atroviride HK4, Trichoderma virens GV41, and mixtures thereof,
said lignin fraction comprises fragments having a weight average molecular weight of 4,000-6,000 Daltons, as measured by Size-Exclusion Chromatography, said fragments comprising 22-33 phenylpropane units on weight average,
   and wherein the fungus is in a concentration of 1×10⁸ to 2×10¹⁰ spores/g of composition, and the lignin fraction in a concentration of at least 70 wt %, based on the weight of the composition.

In other preferred embodiments, the composition of the invention comprises a fungus of Trichoderma genus and a lignin fraction, wherein:
said fungus is selected from Trichoderma harzianum HK2, Trichoderma atroviride HK4, Trichoderma virens GV41, and mixtures thereof,
said lignin fraction comprises fragments having a weight average molecular weight of 9,000-11,000 Daltons, as measured by Size-Exclusion Chromatography, said fragments comprising 50-61 phenylpropane units on weight average,
   and wherein the fungus is in a concentration of 1×10⁸ to 2×10¹⁰ spores/g of composition, and the lignin fraction in a concentration of at least 70 wt %, based on the weight of the composition.

The most preferred embodiments are those where the composition of the invention comprises a fungus of Trichoderma genus and a lignin fraction, wherein:
said fungus is Trichoderma virens GV41,
said lignin fraction comprises fragments having a weight average molecular weight of 9,000-11,000 Daltons, as measured by Size-Exclusion Chromatography, said fragments comprising 50-61 phenylpropane units on weight average,
   and wherein the fungus is in a concentration of 1×10⁹ to 2×10¹⁰ spores/g of composition, and the lignin fraction in a concentration of 75-95 wt %, based on the weight of the composition.

Said nitrogen-containing fertilizer is a fertilizer comprising urea, ammonia, ammonium nitrate, ammonium sulfate, calcium nitrate, diammonium phosphate, monoammonium phosphate, potassium nitrate, sodium nitrate, or a mixture thereof, as a source of nitrogen. As said, the composition comprising a fungus of Trichoderma genus and a lignin fraction has been shown to unexpectedly and significantly increase the nitrogen uptake by plant seeds, so that the overall use of traditional nitrogen-containing fertilizer can be advantageously reduced, even down to half amount.

Preferably, said fertilizer can also comprise a source of phosphorus, a source of potassium or a mixture thereof.

Suitable sources of phosphorus include diammonium phosphate, monoammonium phosphate, monopotassium phosphate, dipotassium phosphate, tetrapotassium pyrophosphate, potassium metaphosphate, and mixtures thereof.

Suitable sources of potassium include potassium chloride, potassium nitrate, potassium sulfate, monopotassium phosphate, dipotassium phosphate, tetrapotassium pyrophosphate, potassium metaphosphate, and mixtures thereof.

In preferred embodiments, the fertilizer contains nitrogen, phosphorous and potassium sources in a N:P:K ratio selected from the group consisting of 29-3-4, 16-4-8, Oct. 10, 2010, 15-5-10, 15-0-15, 22-3-14, 20-28-5 and 12-6-6.

Optionally, the fertilizer can also comprise a macronutrient selected from the group consisting of sulphur, calcium and magnesium and/or micronutrients including boron, copper, iron, manganese, molybdenum and zinc.

The nitrogen-containing fertilizer can be in the form of a liquid, suspensions or solid, such as powder or granules.

The composition above can be used in an amount of 1-1,000 kg per soil hectare (ha), preferably 1-100 kg per ha, more preferably 1-10 kg per ha.

In other embodiments, the present invention concerns the use of a composition consisting essentially of a fungus of Trichoderma genus and a lignin fraction, as a booster of nitrogen uptake by plant seeds receiving nitrogen-containing fertilizer, wherein:
said fungus is selected from Trichoderma species, their protoplast fusants, and mixtures thereof,
said lignin fraction comprises fragments having a weight average molecular weight up to 20,000 Daltons, as measured by Size-Exclusion Chromatography, said fragments comprising up to 111 phenylpropane units on weight average,
   and wherein the fungus is in a concentration of 1×10⁵ to 5×10¹⁰ spores/g of composition, and the lignin fraction in a concentration of at least 40 wt %, based on the weight of the composition. For the purposes of the present invention, the expression “consists essentially of” means that said fungus and said lignin fraction are the only active ingredients acting as plant growth and fruit production promoters which are present in the compositions, the possible other components having different activities or being simple co-formulants.

In further embodiments, the present invention concerns the use of a composition consisting of a fungus of Trichoderma genus and a lignin fraction, as a booster of nitrogen uptake by plant seeds receiving nitrogen-containing fertilizer, as above described.

It should be noted that all the preferred aspects of the use of the composition the present invention are deemed to be similarly preferred also for the embodiments defined by the terms “consisting essentially of” and “consisting of”.

In another aspect, the present invention also concerns an agro-chemical kit comprising:
a first container containing a fungus of Trichoderma genus,
a second container comprising a lignin fraction, and
a third container comprising a nitrogen-containing fertilizer, or
a first container containing a fungus of Trichoderma genus, and
a second container comprising a lignin fraction and a nitrogen-containing fertilizer, said fungus, said lignin fraction and said fertilizer being as above described.

In the embodiments comprising three containers, the ingredients are kept apart of one another, thus preserving them better and even metering each of them in an easier way at the time of their combined use.

In the embodiments comprising two containers, the fungus of Trichoderma genus is kept apart of lignin fraction and fertilizer, the latter being more compatible to each other, while reducing the overall packaging.

Therefore, depending on the instant needs, the agro-chemical kit of the invention can be provided in the more suitable embodiment among the alternatives above.

Said containers can be sacks, bags, envelopes, boxes, drums, bottles or cans.

Preferably, in the agro-chemical kit:
said first container contains solid granules a) comprising the fungus of Trichoderma genus in a concentration of 1×10⁵ to 1×10¹⁰ spores/g of granules a), and at least one binding agent, and
said second container contains solid granules b) comprising the lignin fraction in a concentration at least 50 wt %, on the weight of granules b), having the granules a) and granules b), independently of each other, an average particle size distribution D₅₀ of 0.2-4.0 mm, as measured by sieve analysis in accordance with EN 1235.

Actually, granular formulations encompass some advantages, such as:
absence of dustiness,
easy sliding in mechanical devices (without undesired packing effects),
easiness to store,
possibility of slow-release formulations,
uniform nutrient distribution,
no segregation of the nutrients during the handling or spreading of the product,
higher efficiency for preplant application.

As said, granules a) and granules b) have, independently of each other, an average particle size distribution D₅₀ of 0.2-4.0 mm. For the purposes of the present invention, this parameter is measured by sieve analysis in accordance with EN 1235 [i.e. EN 1235: Solid fertilizers—Test sieving (ISO 8397:1988, modified) (including Amendment A1: 2003)]. The average grain size and the particle size distribution are important quality characteristics for solid fertilizers and related products. Sieve analysis has been declared the obligatory process for the determination of particle size distribution for solid fertilizer products sold in the European Union and all associated instruments and procedures are governed by EN 1235. In accordance with EN 1235, solid fertilizers are to be subjected to a screening analysis employing 200-millimeter diameters laboratory test sieves manufactured according to the requirements of ISO 3310-1. The standard calls for a maximum of seven test sieves to be used for the gradation test, covering the complete size distribution spectrum of the sample material. The selection of aperture sizes should be made from the R20/3 series of ISO 565, although the use of additional sieves from the R20 series is explicitly permitted in the standard. The requirements of EN 1235 were determined in a series of ring trials using Woven Wire Cloth Sieves with aperture width from 100 μm to 5.60 mm.

Granular products are solid homogeneous mixtures generally produced in granulation plants by combining various raw materials. Each uniformly sized particle contains all the components in the analysis.

Different granulation processes are known, such as:
dry granulation,
wet granulation,
by spray dryer,
fluidized bed spray,
pan granulator.

In preferred embodiments, Trichoderma fungus and lignin fraction are separately granulated in different and distinct granulation processes obtaining granules a) and granules b) respectively, that can be mixed with each other to give a solid admixture, and long-term stored and then re-dispersed or re-suspended in liquid formulations upon use, while keeping their activity and efficacy.

Preferably, the Trichoderma fungus is in a concentration of 1×10⁵ to 1×10¹⁰ spores/g of granules a).

Preferably, in granules a), said at least one binding agent is selected from kaoline, starch, modified starch, starch phosphate, pectin, modified pectin, amylopectin, alginic acid, sodium alginate, guar gum, guar flour, tragacanth, gum arabic, xanthan gum, karaya gum, tara gum, tamarind gum, gellan gum, locust bean gum, gelatin, carob seed flour, galactomannan, glucomannan, dextran, carrageenan, mannan, arabinogalactan, pullulan, maltodextrin, cellulose, derivatized cellulose, carboxymethyl cellulose, sodium carboxymethyl cellulose, soy polysaccharide, chitosan, or a mixture thereof.

More preferably, said at least one binding agent is selected from starch, modified starch, starch phosphate, and mixtures thereof.

In preferred embodiments, granules a) further comprise wetting agents, disintegrating agents, dispersing agents, or mixtures thereof.

Wetting agents can reduce the surface tension of water, allowing the wetting agents to enter hydrophobic soil medium and thereby facilitate infiltration; they vary in their effect on water surface tension, water infiltration and water retention. A suitable wetting agent is selected from the group consisting of alkylsulfate salts, arylsulfonate salts, polyoxyalkylene alkyl ethers, alkenylsulfonate salts, polyoxyethylene styryl phenyl ethers, polyoxyethylene distyryl phenyl ethers, polyoxyethylene tristyryl phenyl ethers, polyoxyethylene styryl phenyl ether salts, polyoxyethylene distyryl phenyl ether salts, polyoxyethylene tristyryl phenyl ether salts, and N-acylamino acid salts.

Preferred wetting agents are arylsulfonate salts such as Sodium Isopropyl Naphthalene Sulfonate.

Disintegrating agents are excipients that are incorporated into the granules to promote their disintegration when they come into contact with liquid or fluid matter. Suitable disintegrating agents include water-soluble polymers and polysaccharides. Dispersing agents are substances, typically surfactants, that are added to improve the separation of the particles and to prevent their settling or clumping. Suitable dispersing agents are polycarboxylates, such as sodium polycarboxylate.

In some embodiments, granules b) consists essentially of lignin fraction.

In other embodiments, granules b) consists of lignin fraction.

Preferably, granules b) comprise the lignin fraction in a concentration of 65-95 wt %, on the weight of granules b), more preferably 70-90 wt %.

Granules b) can further comprise at least one carrier.

Preferably, in granules b), said at least one carrier is selected from lignosulphite, chalk, carboxymethylcellulose, a carbonate, hydrogen carbonate, sulphate, phosphate, oxide, or hydroxide, of potassium, sodium, lithium, calcium, magnesium, zinc, or ammonium, or urea salt or a mixture thereof.

More preferably, said at least one carrier is selected from a carbonate of potassium, or sodium, or salts of ammonia or urea and mixtures thereof.

Preferably, said granules a) and said granules b) have, independently of each other, an average particle size distribution D₅₀ of 0.5-2.0 mm.

In preferred embodiments, the average particle size distribution D₅₀ of said granules a) and the average particle size distribution D₅₀ of the said granules b) are in a ratio of 3:1 to 1:3, more preferably 2:1 to 1:2.

In particularly preferred embodiments, said granules a) and said granules b) have approximately the same average particle size distribution D₅₀.

In the most preferred embodiments, no particles having size below 0.2 mm are present in the solid mixture.

Preferably, said granules a) and said granules b) have, independently of each other, a bulk density (loose) of 0.3-0.8 g/ml, preferably 0.4-0.7 g/ml, according to ISO 3944:1992. The following standards contain provisions which, through reference in this text, constitute provisions of this International Standard:
ISO 7742:1988, Solid fertilizers-Reduction of samples.
ISO 8358:1991, Solid fertilizers-Preparation of samples for chemical and physical analysis.

For the purposes of this International Standard, the “bulk density (loose) of a fertilizer” is defined by the mass per volume of a material after it has been tipped freely into a container under specified conditions. The bulk density (loose) is expressed in grams per cubic centimetre (g/cm³).

Although these standards refer to “fertilizers”, the same have been considered by the inventors, as suitable and adoptable references also for the instant characterization.

In preferred embodiments, said granules a) and said granules b) have approximately the same bulk density (loose).

The fact that granules a) and granules b) have similar average particle size distribution D₅₀ and/or density is important in order to minimize the risk that larger or heavier granules would not be homogeneously mixed, thus leading to unbalanced administration of the composition components, when re-dispersed or re-suspended in liquid formulations upon use.

Preferably, the kit of the invention comprises 0.1-20 wt % of granules a) in the first container, and 80-99.9 wt % of granules b) in the second container, based on the weight of their solid admixture. This means that these respective “wt %” are calculated on the basis of the sum of granules a) and granules b) weights.

Particularly, in the agro-chemical kit:
i) when said at least one carrier in granules b) is water dispersible or water soluble, the kit comprises 1-15 wt % of granules a) and 85-99 wt % of granules b), based on the weight of their solid admixture, and
ii) when said at least one carrier in granules b) is not water dispersible nor water soluble, the kit comprises 0.1-5 wt % of granules a) and 95-99.9 wt % of granules b), based on the weight of their solid admixture.

In preferred embodiments of option i), said at least one carrier in granules b) comprises potassium carbonate, ammonia salt, urea salt, or a mixture thereof.

In preferred embodiments of option ii), said at least one carrier in granules b) comprises calcium sulphate, lignosulphite, chalk, carboxymethylcellulose, or a mixture thereof.

In further preferred embodiments, the second container of the kit comprises both:
i) granules b) wherein said at least one carrier is water dispersible or water soluble, and
ii) granules b) wherein said at least one carrier is not water dispersible nor water soluble.

It should be appreciated that granules b) as per option i), i.e. including at least one water dispersible or water soluble carrier, can be considered fast-release granules; in fact, the lignin fraction is easily released upon contact with water.

Similarly, it should be appreciated that granules b) as per option ii), i.e. including at least one non-water dispersible or non-water soluble carrier, can be considered slow-release granules.

Therefore, the efficacy and activity overtime of the resulting composition once applied, can be pre-set by modulating the concentration of different granules b).

Exemplary agro-chemical kits according to the invention are reported below:
a fast-release kit comprising 1 wt % of granules a) comprising starch and 5×10⁹ spores/g Trichoderma in the first container, and 99 wt % of granules b) (75 wt % lignin fraction+25 wt % potassium carbonate) in the second container, based on the weight of their solid admixture,
a slow-release kit comprising 0.1 wt % of granules a) comprising starch and 5×10⁹ spores/g Trichoderma in the first container, and 99.9 wt % of granules b) (85 wt % lignin fraction+15 wt % calcium sulphate) in the second container, based on the weight of their solid admixture.

Preferably, an extrusion granulation is performed for preparing granules a), where fine powders of Trichoderma spores and at least one binding agent are mixed with water (10-20%) to produce a wet mixture. This mixture is passed through an extruder or pan granulator to obtain wet granules, that are then dried in an oven or fluid bed.

In particular, granules a) of vital spores of Trichoderma that are water dispersible are preferably prepared by the steps of:
milling together solid ingredients to obtain a homogeneous pre-mix,
adding water to the pre-mix to obtain a wet mixture,
granulating the wet mixture by any suitable technique, such as extrusion, pan granulation, agglomeration, dry spray, etc.

Preferably, the pre-mix is obtained by mixing together the following solid ingredients:

| | | |
|---|---|---|
| Trichoderma spores | 10-90 | wt. % |
| Wetting agent | 1-3 | wt. % |
| Dispersing agent | 2-15 | wt. % |
| Disintegrating agent | 0-15 | wt. % |

| | |
|---|---|
| Binding agent | to 100 wt. % |

Lignin fractions typically used in the present invention are not soluble in water at neutral pH, but are soluble at basic pH.

It has been then found that water-dispersible granules b) of lignin fraction can be thus obtained by adding at least one water dispersible or water soluble carrier—which is an alkaline compound—to lignin, thus solubilizing lignin in water at basic pH. Solubilized lignin forms a colloidal dispersion in water.

Then, the solubilized lignin fraction is diluted in water at neutral pH, thus obtaining a solution/dispersion of lignin in water at pH that is physiological for plants, i.e. neutral or slightly basic pH.

Preferably the carrier is potassium carbonate.

Therefore, granules b) of lignin fractions that are water dispersible are preferably prepared by the steps of:
adding at least one water dispersible or water soluble carrier to lignin fraction, preferably potassium carbonate, the lignin fraction preferably having a dry matter content of 60-70%;
mixing up to a homogeneous paste, thus obtaining a water-dispersible lignin fraction paste;
wet granulating the water-dispersible lignin fraction paste, thus obtaining granules b).

The term dry matter content denotes solid matter content in a mixture. It is calculated as a percentage of solid material in the total mass of the mixture, % by weight.

Granulation of lignin fraction alone (i.e. without Trichoderma spores) allows taking advantage of the good thermal and chemical stability of lignin (and to avoid exposing Trichoderma to alkaline formulations in case of water-dispersible formulations), thus permitting the use of process conditions that are very advantageous in terms of costs and yield.

Non-water dispersible granules b) of lignin fraction are preferably prepared by the steps of:
providing a lignin fraction preferably having a dry matter content of 60-70%,
optionally, adding at least one non-water dispersible or non-water soluble carrier, preferably lignosulphite, chalk, carboxymethylcellulose, calcium sulphate, or a mixture thereof;
granulating the lignin fraction, optionally mixed with said carrier, in a blade rotor, inducing formation of granules by mechanical action, and
drying granules in a fluidized bed.

Due to the capacity of aggregation of lignin, the use of non-water dispersible or non-water soluble carriers is not strictly necessary. However, addition of carriers ameliorates granules texture and avoids breaking up of granules during handling, storage and use in agricultural machinery, which would otherwise produce undesired powder. It should be appreciated that the composition above described to be used as a booster of nitrogen uptake by plant seeds receiving nitrogen-containing fertilizer, can similarly comprise a fungus of Trichoderma genus and a lignin fraction, in the forms of granules a) and granules b) respectively, as above disclosed with respect to the agro-chemical kit. Accordingly, it should be understood that all the preferred aspects of granules a) and granules b) and their combinations, are to be deemed as hereby disclosed and similarly preferred also for the use of the composition as a booster of nitrogen uptake by plant seeds receiving nitrogen-containing fertilizer.

In a further aspect, the present invention relates to a method for increasing the nitrogen uptake by plant seeds receiving nitrogen-containing fertilizer, said method comprising the steps of:
A) applying the composition above described to seed soil, and
B) applying a nitrogen-containing fertilizer, so as to provide nitrogen in an amount not higher than 50% of the recommended amount for the plant to be fertilized.

Preferably in this method, the composition and the nitrogen-containing fertilizer are provided in the form of the agro-chemical kit above described. In this regard, preferably, the agro-chemical kit further comprises instructions (e.g. an instruction leaflet) for implementing the method above reported.

In step A), the composition above described is applied to seed soil.

With the term “seed soil” is meant to denote the soil wherein the seeds will be or have been previously sowed, such as compost, humus, peat, sand, sawdust, coconut fiber, and combinations thereof.

Preferably, the composition is mechanically mixed with the soil, wherein the seeds are already sowed or wherein the seeds are sowed subsequently. This means that seeds can be mixed together with the composition and soil, or seeds can be sowed after the composition and soil have been mixed.

Preferably, the composition is applied in an amount of 0.01-1.00 kg/m³ of seed soil. More preferably, the composition is applied in an amount of 0.05-0.70 kg/m³ of seed soil. In preferred embodiments, the composition is applied in an amount of 0.10-0.50 kg/m³ of seed soil.

In step B), a nitrogen-containing fertilizer is applied to said seed soil, so as to provide nitrogen in an amount not higher than 50% of the recommended amount for the plant to be fertilized.

With the term “recommended amount” should be interpreted as the amount of nitrogen that official Guidelines issued by competent agricultural authorities, as well as fertilizers' producers, indicate as appropriate for the specific plant to be grown. An example is “Guidelines on Nitrogen Management in Agricultural Systems” issued by International Atomic Energy Agency, Vienna, on February 2008 (IAEA-TCS-29, ISSN 1018-5518). As a matter of fact, it was observed that the effect on nitrogen uptake is so increased by the composition of the invention, that it is possible to reduce down to 50% the supplementation of nitrogen-containing fertilizer, while anyway achieving appreciable and comparable results.

Said effect has been evidenced by a number of tests performed on different plants germinated and grown from seeds treated as above, particularly wheat, corn and soy, such as:
SPAD, i.e. Soil Plant Analysis Development chlorophyll meter, which is a rapid and non-destructive approach for measuring the chlorophyll content, thus determining in situ nitrogen (N) status. This is one of the most commonly used diagnostic tools to measure crop nitrogen status, in particular determining the relative amount of chlorophyll present by measuring the absorbance of the leaf in two wavelength regions, i.e. red and near-infrared regions. Using these two absorbances, the meter calculates a numerical SPAD value which is proportional to the amount of chlorophyll present in the leaf. The chlorophyll content, represented by the measured SPAD value, will increase in proportion to the amount of nitrogen present in the leaf. A higher SPAD value indicates a healthier plant.

With respect to the tests performed on wheat, corn and soy, it was observed that the composition alone allows to increase the SPAD value, as compared to the untreated samples; however, the combination of the composition and fertilizer (either in an amount typically applied, or in a halved amount) allowed to further increase the SPAD value.
PE Nitrogen, i.e. the Physiological Efficiency denoting the ability of the plant to transform Nitrogen acquired from the source applied into economic yield. In other words, PE is defined as the yield increase in relation to the increase in crop uptake of the nutrient in above-ground parts of the plant. This is calculated according to the following formula:

$$PE = ( Y - {Y}_{0} ) / ( U - {U}_{0} )$$

wherein Y=yield of harvested portion of crop with nutrient applied; Y₀=yield with not nutrient applied; U=total nutrient uptake in aboveground crop biomass with nutrient applied; U₀=nutrient uptake in aboveground crop biomass with no nutrient applied; Units are not shown since the expressions are ratios on a mass basis and are therefore unitless in their standard form (values of 40-60 are common).
AE Nitrogen, i.e. the Agronomic Efficiency denoting the productivity improvement gained by use of Nitrogen input. This is calculated in units of yield increase per unit of nutrient applied. It more closely reflects the direct production impact of an applied fertilizer and relates directly to economic return. The calculation of AE requires knowledge of yield without nutrient input, so is only known when research plots with zero nutrient input have been implemented on the farm. The following formula is used:

$$A E = ( Y - {Y}_{0} ) / F$$

wherein Y=yield of harvested portion of crop with nutrient applied; Y₀=yield with not nutrient applied; F=amount of nutrient applied; Units are not shown since the expression is a ratio on a mass basis and is therefore unitless in its standard form.
IE Nitrogen, i.e. the Internal utilization Efficiency denoting the ability of the plant to transform Nitrogen acquired from all sources into economic yield. In other words, IE is defined as the yield in relation to total nutrient uptake. A very high IE suggests deficiency of that nutrient. Low IE suggests poor internal nutrient conversion due to other stresses (deficiencies of other nutrients, drought stress, heat stress, mineral toxicities, pests, etc.). This is calculated according to the following formula:

$$IE = Y / U$$

wherein Y=yield of harvested portion of crop with nutrient applied; U=total nutrient uptake in aboveground crop biomass with nutrient applied; Units are not shown since the expression is a ratio on a mass basis and is therefore unitless in its standard form (values of 30-90 are common for N in cereals and 55-65 considered optimal).

P and K can either be expressed on an elemental basis (most common in scientific literature) or on an oxide basis as P₂O₅ or K₂O (most common within industry).

With respect to the tests performed on wheat, corn and soy, it was observed that the composition alone allows the crops to uptake more nitrogen, as compared to the untreated samples, and similar nitrogen, as compared to the fertilizer-treated samples; however, the combination of the composition and fertilizer (in an amount typically applied, but even better in a halved amount) allowed to further increase the overall nitrogen uptake. It should be appreciated that the experimental evidence clearly support the possibility of substituting nitrogen-containing fertilizer with a combination of “composition+a half amount of nitrogen-containing fertilizer”, while achieving the same, or even incremented, nutritional results in plant seedlings. This allows to reduce the fertilizer to be used down to 50% of the typically supplemented amount.

It should be understood that all the preferred aspects of the composition and the agro-chemical kit of the invention, are similarly deemed to be preferred for preparation processes, methods, and uses of the same.

It should be also understood that all the combinations of preferred aspects of the composition of the invention, as well as of the agro-chemical kit, preparation processes, methods, and uses of the same, as above reported, are to be deemed as hereby disclosed. Below are working examples of the present invention provided for illustrative purposes.

### EXAMPLES

M_{w} and Mₙ in these Examples were measured by Size-Exclusion Chromatography according to the following procedure.

“wt %” means weight percentage based on the weight of the organic-inorganic hybrid material, unless otherwise specified.

### Reagents and Materials

Eluent: 0.1 M NaOH, flow 0.5 ml/min
Calibration for RI detector: Pullulan standards, Mₚ: 100,000-1,080 (six standards), where Mₚ is peak maximum molecular weight
Calibration for UV-detector (280 nm): PSS standards, polystyrenesulfonate sodium salt, Mₚ 65,400-891 (six standards). Standards are dissolved into ultra-pure water, concentration should be approximately 5 mg/ml. Injection volume is 20 μl.
Quality control samples: lignin with known M_{w} distribution is used.

### Equipment and Instruments

Dionex Ultimate 3000 Autosampler, column compartment, and pump
Dionex Ultimate 3000 Diode Array Detector
Reflective Index detector: Shodex RI-101
Columns: PSS MCX columns: precolumn and two analytical columns: 1000 Å and 100 000 Å, column material is sulfonated divinylbenzen copolymer matrix.
Syringe filters 0.45 μm and glass sample bottles for STD samples. Sample filtration: Mini-Uniprep syringeless filter device PTFE or Nylon, 0.45 μm. For prefiltration 5 μm syringe filter if needed.
Measuring bottles

### Procedure

### Preparation of the Eluent

Ideally, water used to prepare eluents should be high quality deionized water of low resistivity (18 MΩ·cm or better) that contains as little dissolved carbon dioxide as possible. The water must be free of biological contamination (e.g., bacteria and molds) and particulate matter.
Needle washing with 10% MeOH-water

### Liquid Samples

Strong alkaline liquor samples are diluted 1:100 and filtered with PTFE syringe filters (0.45 μm) to vials. Solid lignin samples are diluted and dissolved into 0.1 M NaOH and filtered with PTFE, 0.45 μm syringe filters. Ready samples are load into autosampler. Injection volume is 20 μl. After samples 1 M NaOH is injected as a sample to clean the column.

### Instrument Parameters:

Flow rate 0.5 ml/min
Eluent 0.1 M NaOH
Column oven temperature 30° C.
Isocratic run
Run time 48 minutes

### Solid Samples

Solid samples (lignin) are dried overnight in an oven at 60° C., if needed. Approximately 10 mg is weighed into a 10-ml measuring bottle. Sample is dissolved and diluted into 0.1 M NaOH solution and filled into a mark. Sample is filtered with PTFE, 0.45 μm filters. If sample does not dissolve properly, it can be put in a ultrasound water bath or sample can be filtered through a 5 μm syringe filter.

### Standard Samples for Calibration

Approximately 50 mg of each standard is weighed into a 10-ml measuring bottle and ultrapure water is added and filled into a mark. Standards are filtered with PTFE 0.45 μm syringe filters. After running the calibration samples, calibration results are integrated and processed in the processing method and saved. Calibration is linear 1st order calibration.

### Quality Control Samples

For lignin samples, lignin with known M_{w} distribution is used as a quality control sample. Lignin is dissolved into 0.1 M NaOH and the concentration is approximately 1 mg/ml.

### Example 1

Beech wood (Fagus sylvatica) was subjected to an alkaline and enzymatic hydrolysis whereby lignin fraction free from hemicellulose and cellulose was obtained. Lignin fraction thus separated has the following characteristics:
>95% of total solids
M_{w} 9,000-11,000 Da (50-61 phenylpropane units)
essentially sulphur-free (sulphur content less than 3%)
comprises 23-29 wt % of cellulose.

### Example 2

The following lignin fraction was extracted from Kraft black liquor, said lignin fraction having the following characteristics:
>95% of total solids

### Single Species: Southern Pine

| | |
|---|---|
| M_{w} | 4400-5000 Da (24-28 phenylpropane units) |
| Mₙ | 1200-1300 Da (6-7 phenylpropane units) |

### Structures of OH-groups:

| | |
|---|---|
| aliphatic | 2.1 mmol/g |
| carboxylic | 0.5 mmol/g |
| condensated and syringyl | 1.7 mmol/g |
| guaiacyl | 2.0 mmol/g |
| catecholic and p-OH-phenyl | 4.0 mmol/g |

### Example 3

### Preparation of Granules a) of Trichoderma Fungus

A pre-mix was prepared by milling together the following ingredients:

| Ingredient | Supplier | Amount (wt. %) |
|---|---|---|
| Trichoderma spores (GV41) | Green | 20 |
| | Innovation | |
| | GmbH | |
| Wetting agent (Supragil ®, Sodium | Solvay | 2 |
| Isopropyl Naphthalene Sulfonate) | | |
| Dispersing agent (Geropon ® | Solvay | 3 |
| TA/72, sodium polycarboxylate) | | |
| Binding agent (ARGIREC ™ B22, | Lehvoss | 75 |
| kaoline) | | |

The pre-mix was granulated by extrusion granulation:
first, the fine powders pre-mix has been mixed with water (15 wt %) to produce a moistured mixture. Then, the moistured mixture was passed through an extruder (i.e. a basket) to obtain wet granules, having the shape of cylindrical micro-pellets. The granules were then dried in a fluidized bed dryer.

Water-dispersible granules comprising 1-2 10¹⁰ vital spores for gram of granule were obtained, having a particle size distribution D₅₀ of 1.5 mm, sieved in a fraction between 1400 microns and 500 microns, as measured by sieve analysis in accordance with EN 1235.

### Example 4

### i) Preparation of Water Dispersible Granules b) of Kraft Lignin Fraction

Water dispersible granules b) of lignin fraction of Example 2 were prepared as follows:
1) dry mixing powders of lignin fraction (having a dry matter content of 70%) and potassium carbonate, in a weight ratio of 70:30,
2) mixing, up to complete extinction of exothermic reaction, and
3) granulating the resulting mixture in a blade rotor, inducing formation of granules by mechanical action,
4) drying granules in a fluidized bed, having an average particle size distribution D₅₀ of 1 mm, sieved in a fraction between 1400 microns and 250 microns as measured by sieve analysis in accordance with EN 1235.

### ii) Preparation of Non-Water Dispersible Granules b) of Lignin Fraction

Non-water dispersible granules b) of lignin fraction were prepared as follows:
1) providing a lignin fraction having a dry matter content of 65%,
2) adding 3 wt % of lignosulphite,
3) granulating the mixture in a blade rotor, inducing formation of granules by mechanical action,
4) drying granules in a fluidized bed, the granules having an average particle size distribution D₅₀ of 2 mm, sieved in a fraction between 2000 microns and 250 microns as measured by sieve analysis in accordance with EN 1235.

### Example 5

### a) Preparation of an Agrochemical Kit Comprising the Granules a) of Ex. 3 and Granules b) of Ex. 4.i

An agro-chemical kit was prepared by combining:
a first bag comprising 30 g of granules a) of Example 3,
a second bag comprising 970 g of water dispersible granules b) of Example 4.i, and
a third bag comprising 150 g of ammonium nitrate.

### b) Preparation of an Agrochemical Kit Comprising the Granules a) of Ex. 3 and Granules b) of Ex. 4.ii

An agro-chemical kit was prepared by combining:
a first bag comprising 40 g of granules a) of Example 3,
a second bag comprising 996 g of non-water dispersible granules b) of Example 4.ii., and 200 g of ammonium nitrate.

### Example 6

### Evaluation of Nitrogen Uptake in Corn Seedlings

Pots were provided comprising 240 g of peat as soil for corn seed sowing.

After sowing, the corn seeds have been harvested and grown, then observed from Dec. 15, 2021 to Jan. 14, 2022.

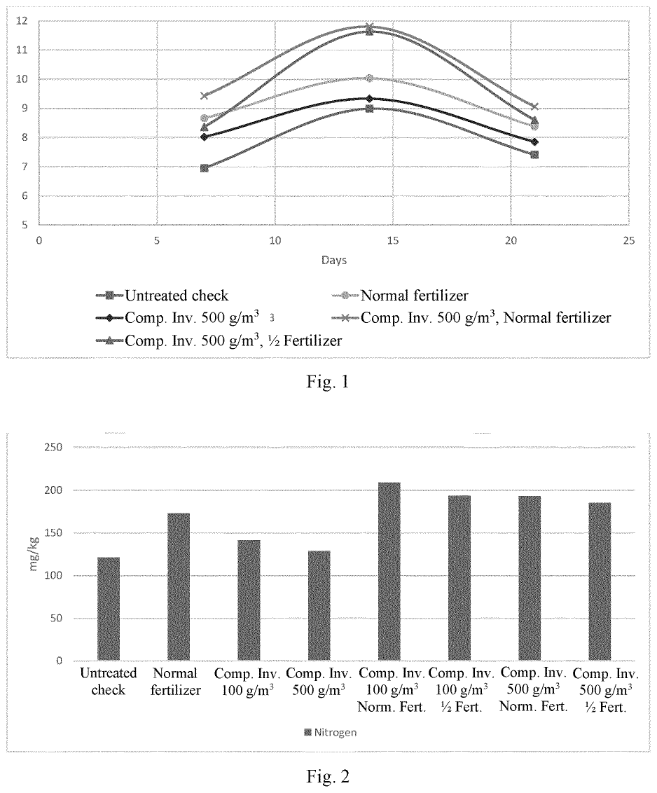

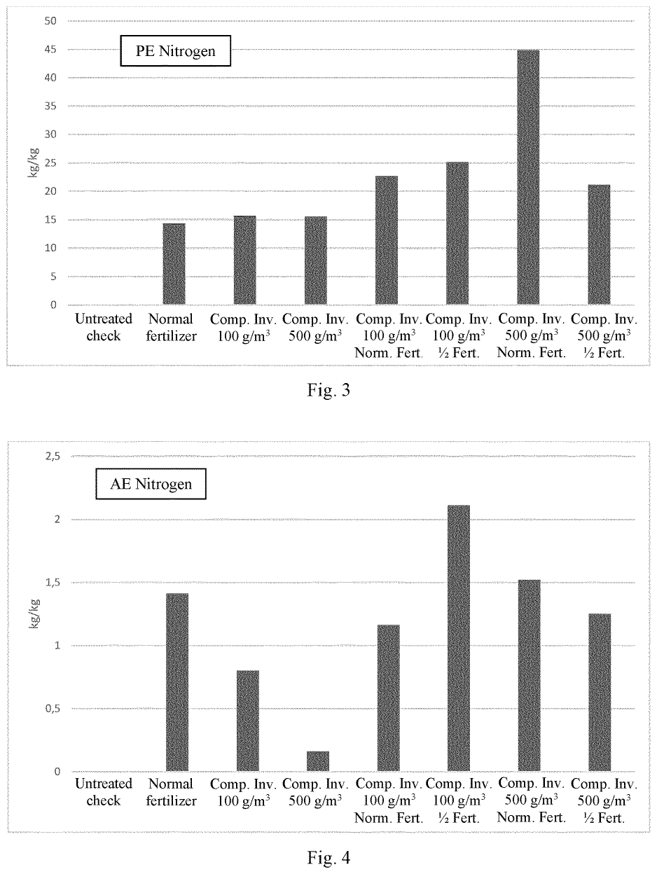

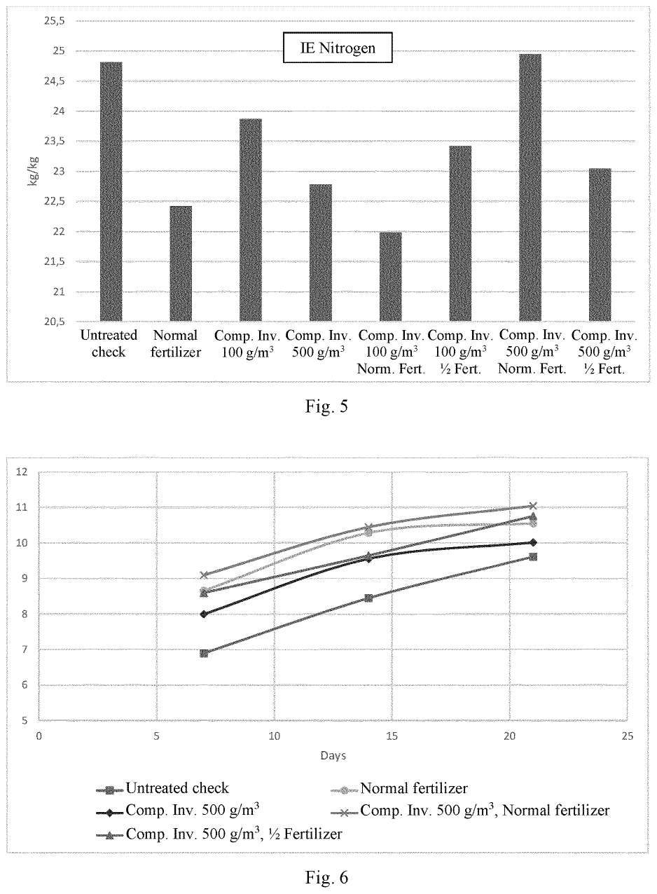

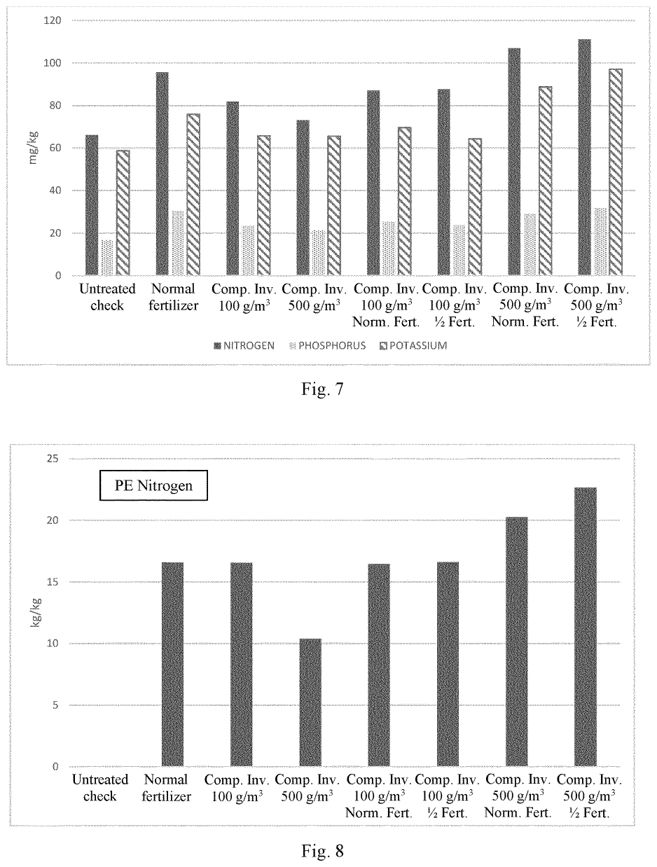

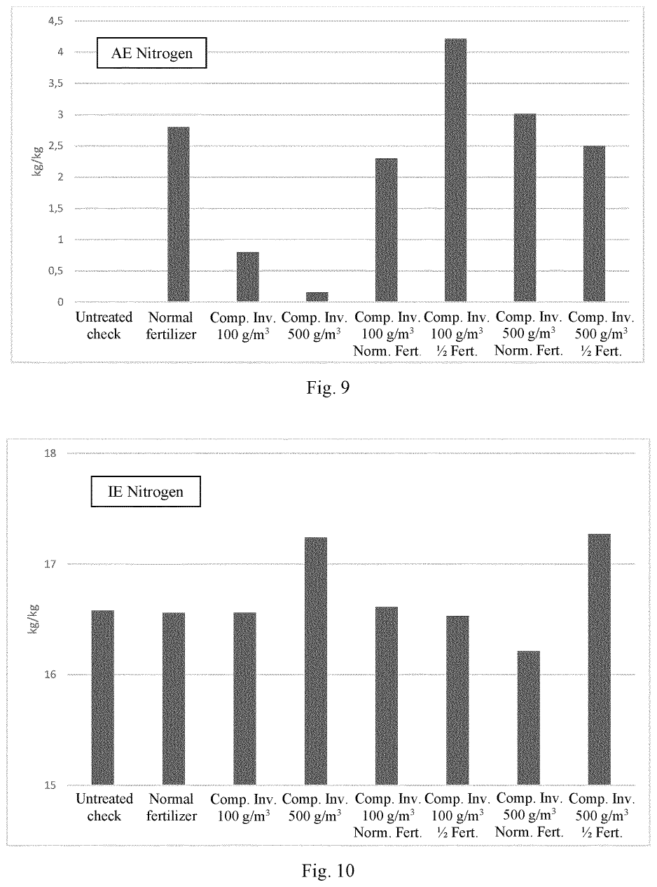

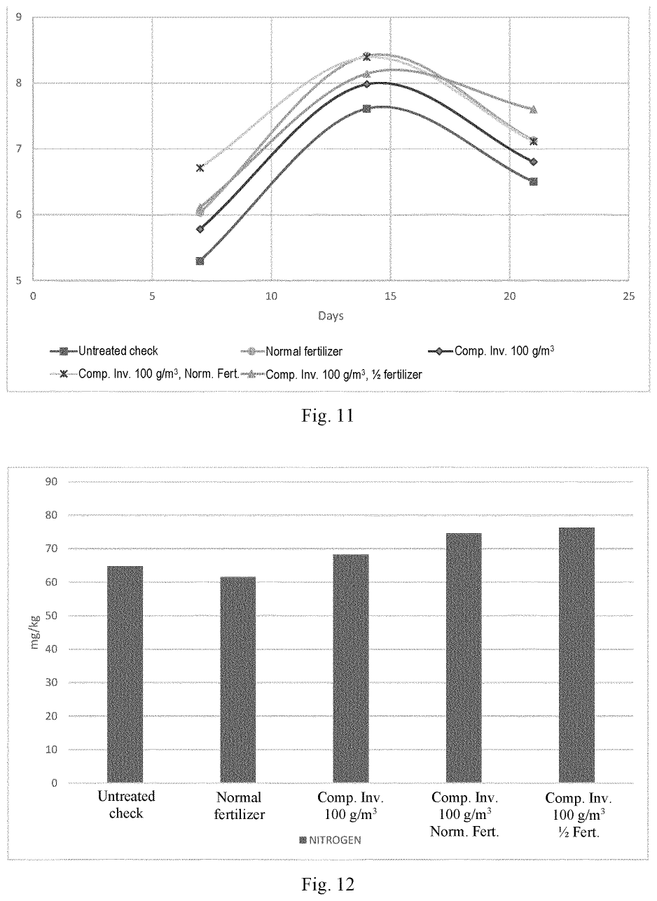

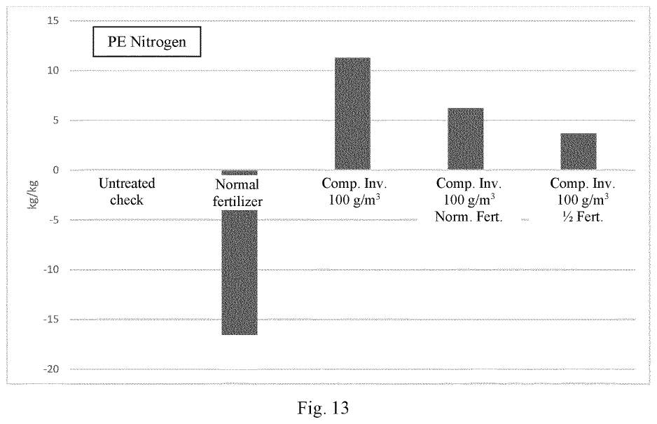

The following samples were prepared and tested, as reported in FIGS. 1-5:
“untreated check”, i.e. corn seedlings receiving no treatment,
“normal fertilizer”, i.e. corn seedlings receiving 150 kg/ha of ammonium nitrate, as fertilizer, at the time of sowing,
“Comp. Inv. 100 g/m³”, i.e. corn seedlings receiving 100 g/m³ of a mixture of Trichoderma GV41 and lignin fraction, at the time of sowing,
“Comp. Inv. 100 g/m³, Norm. Fert.”, i.e. corn seedlings receiving 100 g/m³ of a mixture of Trichoderma GV41 and lignin fraction, and 150 kg/ha of ammonium nitrate, at the time of sowing,
“Comp. Inv. 100 g/m³, ½ Fert.”, i.e. corn seedlings receiving 100 g/m³ of a mixture of Trichoderma GV41 and lignin fraction, and 75 kg/ha of ammonium nitrate, at the time of sowing,
“Comp. Inv. 500 g/m³”, i.e. corn seedlings receiving 500 g/m³ of a mixture of Trichoderma GV41 and lignin fraction, at the time of sowing,
“Comp. Inv. 500 g/m³, norm fert”, i.e. corn seedlings receiving 500 g/m³ of a mixture of Trichoderma GV41 and lignin fraction, and 150 kg/ha of ammonium nitrate, at the time of sowing,
“Comp. Inv. 500 g/m³, ½ fert”, i.e. corn seedlings receiving 500 g/m³ of a mixture of Trichoderma GV41 and lignin fraction, and 75 kg/ha of ammonium nitrate, at the time of sowing;
   where “Comp. Inv.” is a composition comprising granules a) according to the procedure of Example 3 and containing Trichoderma virens GV41 3×10⁷ UFC/g, and water dispersible granules b) according to the procedure of Example 4.i and comprising 100% of lignin fraction.

Comp. Inv. was mechanically mixed with peat, before sowing the corn seeds.

Then, fertilizer was added, in the samples concerned.

The results at the end of the observation period showed that the trend of SPAD (FIG. 1) was increased by the combined use of the composition of the invention and fertilizer. However, the overall uptake of Nitrogen was better achieved when the composition of the invention is used in combination of half amount of fertilizer, as shown in FIG. 2.

FIGS. 3-5 confirmed this finding, insofar as the uptake of nitrogen is better achieved when 100 g/m³ of composition are combined with half amount of fertilizer. As a matter of fact, this combination of concentrations represents the best balance between the overall cost of the composition and the results achieved on plants, with respect to the ‘treated check’ (i.e. conventional fertilizer supplementation).

### Example 7

### Evaluation of Nitrogen Uptake in Wheat Seedlings

The same procedure and tests have been repeated on wheat seeds and resulting seedlings. The results have been reported in FIGS. 6-10.

Also in this case, all the nutrient uptake indicators have confirmed that best results are achieved when the composition of the invention is used in combination of half amount of fertilizer, this is best pointed out in results for 500 g/m³ where uptake of N, P and K were increased. Increase of N uptake is observed especially at lower concentration of the composition itself (i.e. 100 g/m³ of composition). Indeed, also in this case, this combination of concentrations represents the best balance between the overall cost of the composition and the results achieved on plants, with respect to the ‘treated check’ (i.e. conventional fertilizer supplementation).

### Example 8

### Evaluation of Nitrogen Uptake in Soy Seedlings

The same procedure and tests have been repeated on soy seeds and resulting seedlings.

The results have been reported in FIGS. 11-13.

Also in this case, all the nutrient uptake indicators have confirmed that best results are achieved when the composition of the invention is used in combination of half amount of fertilizer, especially at lower concentration of the composition itself (i.e. 100 g/m³ of composition).

In the case of soybeans, as a leguminous plant, the results are even more surprising. As a matter of fact, legumes, such as soy, capture atmospheric nitrogen through a symbiotic relationships with soil bacteria in a process called “biological nitrogen fixation.” This process reduces the reliance on synthetic nitrogen fertilizers. Among legumes, soybeans are a major source of protein and oil. Soybeans are grown in a range of latitudes and environments. One of the challenges to improving soybean productivity is the high demand of nitrogen in comparison to cereals and oilseed crops. Biological nitrogen fixation could be improved by breeding and selection that focuses on the plant, the nitrogen-fixing bacteria, and better matching plant and bacteria, however, the composition of the present invention has given a great contribution to this end.

FIG. 13, in particular, shows that “PE Nitrogen” [i.e. the physiological efficiency (PE) denoting the ability of the plant to transform Nitrogen acquired from the source applied into economic yield] is significantly negative in the treated check, i.e. the sample conventionally fertilized, whereas conversely the composition of the present invention reverses the trend promoting the nitrogen acquisition and exploitation.

1. A method comprises making or using a composition comprising a fungus of Trichoderma genus and a lignin fraction as a booster of nitrogen uptake by plant seeds receiving nitrogen-containing fertilizer, wherein:
said fungus is selected from Trichoderma species, their protoplast fusants, and mixtures thereof,
said lignin fraction comprises fragments having a weight average molecular weight up to 20,000 Daltons, as measured by Size-Exclusion Chromatography, said fragments comprising up to 111 phenylpropane units on weight average, and wherein the fungus is in a concentration of 1×10⁵ to 5×10¹⁰ spores/g of composition, and the lignin fraction in a concentration of at least 40 wt %, based on the weight of the composition.

2. The method of claim 1, wherein said Trichoderma species is selected from Trichoderma aggressivum, Trichoderma asperellum, Trichoderma atroviride, Trichoderma citrinoviride, Trichoderma cremeum, Trichoderma harzianum, Trichoderma koningii, Trichoderma longibrachiatum, Trichoderma reesei, Trichoderma virens, Trichoderma viride, Trichoderma viridescens, and mixtures thereof.

3. The method of claim 1, wherein said fungus is selected from T. harzianum, T. atroviride and T. virens, and mixtures thereof.

4. The method of claim 1, wherein said lignin fraction comprises fragments having a weight average molecular weight of 2,000-20,000 Da, preferably 3,000-20,000 Da, more preferably 4,000-15,000 Da.

5. The method of claim 4, wherein said lignin fraction comprises fragments having a weight average molecular weight of 4,000-8,000 Da.

6. The method of claim 1, wherein said fungus is in a concentration of 1×106 to 3×1010 spores/g of composition, preferably 1×108 to 2×1010 spores/g of composition, more preferably 1×109 to 2×1010 spores/g of composition.

7. The method of claim 1, wherein the lignin fraction in a concentration of at least 60 wt %, preferably, at least 70 wt %, more preferably 75-95 wt %, based on the weight of the composition.

8. The method of claim 1, wherein said nitrogen-containing fertilizer is a fertilizer comprising urea, ammonia, ammonium nitrate, ammonium sulfate, calcium nitrate, diammonium phosphate, monoammonium phosphate, potassium nitrate, sodium nitrate, or a mixture thereof, as a source of nitrogen.

9. An agro-chemical kit comprising:
a first container containing a fungus of Trichoderma genus,
a second container comprising a lignin fraction, and
a third container comprising a nitrogen-containing fertilizer, or
a first container containing a fungus of Trichoderma genus, and
a second container comprising a lignin fraction and a nitrogen-containing fertilizer,
said fungus, said lignin fraction and said fertilizer being for making or using as claimed in claim 1.

10. The agro-chemical kit of claim 9, wherein:
said first container contains solid granules a) comprising the fungus of Trichoderma genus in a concentration of 1×10⁵ to 1×1010 spores/g of granules a), and at least one binding agent, and
said second container contains solid granules b) comprising the lignin fraction in a concentration at least 50 wt %, on the weight of granules b),
having the granules a) and granules b), independently of each other, an average particle size distribution D₅₀ of 0.2-4.0 mm, as measured by sieve analysis in accordance with EN 1235.

11. The agro-chemical kit of claim 10, wherein:
in granules a), said at least one binding agent is selected from kaoline, starch, modified starch, starch phosphate, pectin, modified pectin, amylopectin, alginic acid, sodium alginate, guar gum, guar flour, tragacanth, gum arabic, xanthan gum, karaya gum, tara gum, tamarind gum, gellan gum, locust bean gum, gelatin, carob seed flour, galactomannan, glucomannan, dextran, carrageenan, mannan, arabinogalactan, pullulan, maltodextrin, cellulose, derivatized cellulose, carboxymethyl cellulose, sodium carboxymethyl cellulose, soy polysaccharide, chitosan, or a mixture thereof, and
granules b) further comprise at least one carrier, said at least one carrier being selected from chalk, carboxymethylcellulose, a carbonate, hydrogen carbonate, sulphate, phosphate, oxide, or hydroxide, of potassium, sodium, lithium, calcium, magnesium, zinc, or ammonium, or a mixture thereof.

12. The agro-chemical kit of claim 10, comprising 0.1-20 wt % of granules a) and 80-99.9 wt % of granules b), based on the weight of their solid admixture.

13. The agro-chemical kit of claim 12, wherein:
i) when said at least one carrier in granules b) is water dispersible or water soluble, the kit comprises 1-15 wt % of granules a) and 85-99 wt % of granules b), based on the weight of their solid admixture, and
ii) when said at least one carrier in granules b) is not water dispersible nor water soluble, the kit comprises 0.1-5 wt % of granules a) and 95-99.9 wt % of granules b), based on the weight of their solid admixture.

14. The agro-chemical kit of claim 11, wherein said at least one carrier in granules b) is water dispersible or water soluble and comprises potassium carbonate.

15. The agro-chemical kit of claim 11, wherein said at least one carrier in granules b) is not water dispersible nor water soluble and comprises lignosulphite, chalk, carboxymethylcellulose (CMC), calcium sulphate, or a mixture thereof.

16. The agro-chemical kit of claim 11, wherein the second container comprises both:
i) granules b) wherein said at least one carrier is water dispersible or water soluble, and
ii) granules b) wherein said at least one carrier is not water dispersible nor water soluble.

17. A method for increasing the nitrogen uptake by plant seeds receiving nitrogen-containing fertilizer, said method comprising the steps of:
A) applying the composition made according to claim 1 to seed soil, and
B) applying a nitrogen-containing fertilizer, so as to provide nitrogen in an amount not higher than 50% of the recommended amount for the plant to be fertilized.

18. The method of claim 17, wherein the composition and the nitrogen-containing fertilizer are provided in the form of the agro-chemical kit of claim 9.
